(19) United States
(12) Patent Application Publication
(10) Pub. No.: US 2024/0033730 A1
(43) Pub. Date: Feb. 1, 2024

(54) PCR DETECTION CHIP, ASSOCIATED TEST DEVICE AND IMPLEMENTATION ANALYSIS SYSTEM

(71) Applicant: BFORCURE, MONTREUIL (FR)

(72) Inventors: Maël LE BERRE, PARIS (FR); Claire LEBOUTEILLER, PARIS (FR); Bilal HADJI, PARIS (FR)

(21) Appl. No.: 18/039,707

(22) PCT Filed: Nov. 29, 2021
(86) PCT No.: PCT/EP2021/083320

§ 371 Date: May 31, 2023

(30) Foreign Application Priority Data
Dec. 4, 2020 (FR) 2012675

(51) Int. Cl. B01L 3/00; B01L 7/00

(52) U.S. Cl. CPC B01L 3/502715; B01L 7/52; B01L 2200/025; B01L 2300/168; B01L 2300/0654; B01L 2300/0816; B01L 2300/0854; B01L 2300/18

(57) ABSTRACT

A system for testing a microfluidic sample chip to perform PCR and/or fluorescence type testing of the biological samples. The chip having the form of a hollow block including at least one chamber delimited by an upper wall and a lower wall. The chamber receiving a sample to be tested and the chamber being associated with thermalization element and with a sensor to measure the fluorescence. The system further includes a tab, preferably opaque and/or rigid or semirigid, positioned in the continuation of, and preferably in the same plane as, the walls.

The invention relates to a microfluidic sample chip for testing biological samples, in particular for a PCR and/or fluorescence type analysis, associated test device as well as a system for analyzing biological samples using such a chip.

To carry out a PCR reaction (Polymerase Chain Reaction) in rapid real time, it is necessary to modify as quickly as possible the temperature of the sample mixed with its reagent while preferably measuring its fluorescence. (hereafter rapid “cycling” of the sample). A method and a device of this type are described for example in patent application WO2011/138748.

The PCR reaction is generally implemented in a disposable container because, at the end of the reaction, the large-scale amplification of the DNA target to be detected contaminates the surface of the container with the target to be amplified, which prevents the reuse thereof. The PCR reaction containers are therefore so-called consumable containers.

These PCR consumables must be able to be handled and inserted into the sample test device in a simple, obvious and quick way to facilitate the use thereof, especially in a context where operational efficiency is important.

A specific implementation of PCR is real-time PCR where DNA amplification is measured during the reaction by a fluorescence signal from a probe whose fluorescence depends on the progress of the reaction of amplification. In this case, an important issue of rapid cycling technologies is the design of a consumable receiving the PCR reagent which allows good thermal transmission to the sample so that the temperature of the sample quickly equilibrates with the temperature of the thermal cycling device (or thermal cycler) while ensuring optical accessibility to the sample.

WO 2018/114625 describes in particular a microfluidic sample chip containing a chamber, preferably flat and/or thin, formed between an at least partially transparent face and a heat-conducting face, for example out of aluminum, the transparent face making it possible to monitor the PCR reaction with the help of an optical means, for example a fluorescence probe, while allowing a very rapid variation in the temperature of the sample thanks to the heat-conducting face thereof. Said chip can be used for example in combination with a microfluidic temperature control system as described in this application WO2018/114625, making it possible to very quickly modify the temperature of the sample between two extreme values thereof typical of PCR technology, in a time of the order of a second.

The object of the present invention is to make the structure and the use of the chip described in WO 2018/114625 even simpler, more reliable and more efficient in particular so as to facilitate its industrialization, and to even better meet the needs of current rapid diagnostic orientation tests or to meet emergency contexts which require the ability to carry out reactions such as PCR in a few minutes.

The invention relates to a system for testing a microfluidic sample chip for the PCR type test of biological samples, said chip having the shape of a block, preferably parallelepipedic, comprising at least one hollow chamber for receiving a sample, delimited in particular by a first wall (or lower wall) made of a material with high thermal conductivity, preferably metallic, and a second wall (or upper wall) made at least partially of a transparent material, said block having at least two openings allowing the introduction of the sample into at least one of the chambers and the evacuation of the atmosphere present in the chamber during the introduction of the sample, the first and second walls being parallel to each other, the chip comprising in addition a tab, preferably at least partially opaque and/or rigid or semi-rigid, arranged in the extension and preferably in the same plane as the walls, the chip also comprising a sealing device, arranged in contact with the second wall or upper wall, characterized in that it comprises a lateral wall provided with an opening allowing the passage of the chip towards thermalization means, complementary polarizing means for cooperating with polarizing means on the chip, means for maintaining the chip in contact with the thermalization means after introduction thereof through the opening, which maintains the chip in contact with the thermalization means, which contact is preferably generated by the cooperation of polarizing means on the chip and complementary polarizing means, in particular for starting the sample analysis sequence, said system further comprising means for measuring the fluorescence of the sample.

According to a preferred embodiment, the system for testing a chip according to the invention will include fluorescence imaging means.

According to one embodiment, the test system according to the invention has the shape of a rectangular strip preferably comprising near one of its ends an opening surrounded by a frame of which at least one of the sides is preferably opaque, in particular the side of the frame which is on the tab side, opening in which is housed on one side a plate of highly conductive material, preferably a metal, forming the first wall and on the other side the means for maintaining the chip forming the second wall, the plate of high conductivity material, the block of transparent material and the frame forming the active part of the chip.

According to a preferred embodiment, the system according to the invention will include polarizing means consisting of a notch on the chip, preferably on the tab.

According to one embodiment, the chamber has grooves for facilitating the flow of the sample in the chamber.

According to a preferred embodiment, the system according to the invention will comprise on the block side an adhesive sealing film secured to the tab, extending in the direction of the opening without being secured to the block, the latter comprising at least two openings communicating with the chamber, said sealing film being designed to adhere to said block and seal the openings after filling the chamber with the sample.

According to one embodiment, the system according to the invention will comprise a protective film which can be removed before using the chip, said film being placed on the openings of the transparent block so as to avoid any contamination of the chamber before introducing the sample.

According to a variant, the system according to the invention will comprise an identification label at the tab.

In a preferred variant, the second wall comprises at its periphery on the chamber side a groove in which an adhesive is disposed to seal the second wall to the first wall.

In a variant of the invention, the system according to the invention will comprise at least four chambers arranged side by side and forming a square. In this case, it will comprise an opaque wall arranged between each of the chambers, making it possible to reduce the light transmission between the various chambers and the external environment.

Preferably, the tab will be at least partially opaque in order to prevent the passage of external light as far as the sample once the chip has been inserted into the associated test device. In addition, the tab will preferably be rigid or semi-rigid, arranged in the extension and preferably in the same plane as the walls.

According to a preferred embodiment, the chip according to the invention comprises a sealing means secured to the chip, arranged in contact with the upper wall in order to maintain the sample inside the chamber or chambers once it has been inserted into the chip, which makes it possible to avoid any contamination of the environment by leakage of the sample.

The sealing device secured to the chip will preferably be a sealing film. The sealing film will preferably be placed at least on each opening so as to avoid any contamination from the outside by the sample to be analyzed and therefore to avoid distorting the following results. Said sealing film can be prepositioned on the wafer during the manufacturing stage (see below). Said sealing film makes it possible to seal the openings when the chambers have been filled with their sample to be analyzed.

The sealing film will preferably be self-adhesive on the block side, secured to the tab, extending in the direction of the opening without being secured to the block, the latter comprising at least two openings communicating with the chamber, said sealing film being designed to adhere to said block and seal the openings after filling the chamber with the sample.

According to a variant, the chip will also include a protective film. The protective film can be removed before using the chip, said film being placed on the openings of the transparent block so as to avoid any contamination of the chamber, in particular between the manufacture and the transport of the chip, an external contamination being able to distort the analysis result.

Thus the protective film will be in contact with the upper wall of the chip and will be removed when filling the chamber or chambers. As soon as the filling is over, the sealing film is immediately positioned over the openings, in a sealed manner, in particular for allowing a rise in pressure in the chambers, as explained below.

In this way, the use of sterile packaging of the chip after the manufacture thereof until the use thereof is avoided (as is usually the case for this type of device)

According to another variant, it is the protective cover of the sealing film which acts as a protective barrier between the potentially contaminating exterior and the interior of the chamber before using the chip.

According to a preferred form, the chip according to the invention has the shape of a rectangular strip preferably comprising near one of its ends an opening surrounded by a frame of which at least one of the sides is preferably opaque, in particular the side of the tab allowing its insertion into the associated test device, opening in which is housed on one side a plate of high conductivity material, preferably a metal, forming the first wall and on the other side the block forming the second wall, the plate of high conductivity material, the block (preferably out of a transparent material) and the frame forming the active part of the chip. When the frame is opaque (or partially opaque at least on the tab side) this prevents external light from entering the chamber and generating noise in the fluorescence measurement signal. This takes on even more importance in the case of multi-chamber chips, where the fluorescence from each chamber must be independently detectable. The opaque walls then make it possible to “optically isolate” the chambers from each other and from the outside environment. Thus the tab may have an opaque portion adjacent to the active part of the chip, of sufficient length to be visible outside the test device after the chip have been introduced into the PCR analysis device.

The sample chip can comprise at least 2 chambers, that is to say more generally n chambers (with n being an integer greater than or equal to 2). In a particular case, the n=i*j (i and j being two integers greater than or equal to 1) chambers are arranged side by side and form a square (if I=j) or a rectangle (if i is different from j).

According to a preferred variant, the sample chip according to the invention comprises polarizing means for cooperating with complementary polarizing means in the test device to analyze the sample contained in the chamber in particular for automatically starting the sequence of sample analysis when the chip is inserted into the PCR analyzer and for identifying whether the chip has been inserted upside down.

These polarizing means consist for example of a notch on the chip, preferably on the tab.

Preferably, the rectangular strip has a notch on one of its sides having a polarizing function.

The chip may also include an identification label at the tab.

In order to facilitate the flow of the sample in the chamber, the latter will preferably comprise grooves.

In order to seal the second wall tightly to the first wall, the sample chip according to the invention will preferably comprise at its periphery on the chamber side a groove in which an adhesive will be deposited.

According to a variant embodiment, the sample chip according to the invention will comprise four chambers arranged side by side and forming a square.

According to a preferred embodiment, the sample chip according to the invention is a rectangular wafer whose length is equal to at least twice, preferably at least three times, the width of said wafer in which there is a rectangular (or square) opening near one of its ends, thus defining a frame around the opening. In said opening are housed on one side, (for example above), a window out of a transparent material (a transparent material compatible with the PCR such as for example polypropylene, polymers and copolymers of cycloolefins (COC, COP) and in general amorphous polymers, out of transparent material, resistant to a temperature of at least 110° C.), with a flat outer surface reaching the level of the surface of the wafer and the inner surface comprising a hollow part forming the chamber for receiving the sample to be analyzed. On the other side of the opening (for example below) is arranged an aluminum strip (or any other material compatible with PCR and having a suitable thermal conductivity (see below) whose thickness will preferably be comprised between 100 and 500 microns, said strip resting on the outer edges of the window made out of a transparent material, the window and/or the strip being provided with grooves, preferably at their periphery, making it possible to seal the window and the metal strip, for example with the help of a bonding means such as a glue compatible with PCR (of the silicone type or equivalent). Preferably the metal strip will (slightly) protrude from the (lower) surface of the wafer to so as improve the thermal contact with the heating means of the test device.

The rectangular plate thus has a portion in the extension (preferably) of the frame, acting as a tab allowing the chip to be manipulated (its active part consisting in particular of the window and the metal plate assembled with the help of glue) and to insert and/or remove it from the test device in a simple manner through a slot whose size is complementary to the cross section of the rectangular wafer and position it in a reproducible manner in the test device. In order to facilitate the positioning of the wafer carrying the active part of the sample chip in the test device, provision will preferably be made for polarizing means, preferably on the wafer, for example a notch on one of the sides of the strip, these polarizing means being associated with complementary means in the test device so as to indicate to the user that the wafer is correctly positioned in the device when the polarizing means engage in the complementary means (it is possible to associate sound or light means indicating for example said engagement to the user who can thus trigger the analysis of the sample (either manually or automatically).

These polarizing means can also be used to automatically detect if the chip has been inserted upside down in the device and warn the user via a light or sound signal or the machine-man interface.

The rectangular plate (which includes both the frame and the tab) will preferably be at least partially at the level of the frame, made out of an opaque material (as defined below), for example an opaque black plastic material compatible with the PCR. In fact it has been observed that said opacity, in particular at the level of the frame and in particular when the chip comprises several chambers, made it possible to obtain a better reading of the fluorescence by allowing better isolation from the light between the various chambers and better isolation from the outside light.

Of course, in order to be able to handle said insert easily, the material(s) used must give it sufficient rigidity (rigid or semi-rigid material—see definition below) to allow it to be inserted into the slot provided for this purpose in the test device.

The window made out of transparent material will have at least two openings making it possible to reach the chamber into which the sample to be analyzed is introduced (preferably at each end of the chamber). Preferably, the chamber will include grooves to facilitate the flow of the liquid sample to be analyzed and to avoid the formation of bubbles so as to promote, during the filling of the chamber, the evacuation of the gaseous atmosphere therein.

When the filling of the chamber is over, the openings are sealed, for example with the help of a transparent film compatible with the PCR and the associated fluorescence measurement, which film preferably covers the whole of the window. Said sealing film is preferably pre-positioned on the wafer during the manufacture of the chip according to the invention.

The tab according to another aspect of the invention can receive on one (or more) of its faces a QR Code or a bar code (or any other means of identification) making it possible to identify the chip. It is also possible, given the space available on the tab, to provide a label on which the user can note information.

In order to protect the chip chamber from any contamination, in particular between manufacture and use of the chip (transport), it is planned to cover the openings with a protective film that does not allow residues to inhibit the PCR reaction.

If the tab is preferably flat and arranged in the same plane as the walls, a variant of the invention consists in providing a tab having for example the shape of a protuberance, preferably arranged in the extension of the walls, allowing a better gripping of the chip to introduce it into the test device.

Preferably, an opaque wall will be placed between each of the chambers (for a chip with multiple chambers) making it possible to reduce the light transmission between the various chambers and the external environment.

The sample test device according to the invention may, according to a variant, comprise a side wall having an opening allowing the passage of the chip towards thermalization means, complementary polarizing means for cooperating with the polarizing means on the chip, a block of glass which can move vertically in the direction of the chip after introduction of the latter through the opening and come to press the chip on the thermalization means upon receipt of a control signal generated by the cooperation of polarizing means and complementary polarizing means.

Preferably, the test device will include means for measuring the fluorescence and in particular fluorescence imaging means arranged so as to allow the passage of light from and towards the imaging means.

In this patent application, the following terms will have the following meaning:

The term “material compatible with the PCR” means a material that does not contain PCR inhibitors, does not degrade enzymes, fluorescent probes, dNTPs, oligonuclides and does not absorb oligonucleotides and other sequences of RNA or DNA and does not diffuse molecules that can interact with the functioning of enzymes or change the characteristics of the PCR reaction.

The term “opaque material” means a material whose optical transmission in the visible range in particular, i.e. between 300 nm and 800 nm, is less than 20%, preferably less than 1%, for a material thickness of one millimeter.

The term “transparent material” means a material whose optical transmission, in particular in the visible range, is greater than 80%.

The term “high thermal conductivity material” means a material whose thermal conductivity is greater than 15 w·m−1·K−1.

The term “rigid or semi-rigid material” means a material whose Young's modulus is greater than 10 MPa.

The terms device, test device, sample test device, PCR analysis device are used interchangeably to designate the sample PCR analysis device.

The invention will be better understood with the help of the following exemplary embodiments, given without limitation, together with the figures which represent:

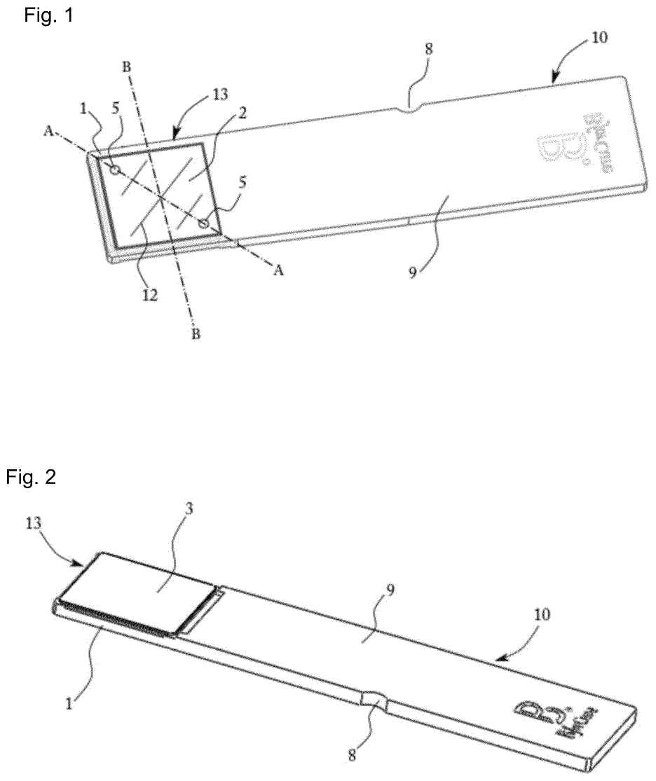

FIG. 1 is a top view of the sample chip according to the invention,

FIG. 2 is a bottom view of the sample chip in FIG. 1,

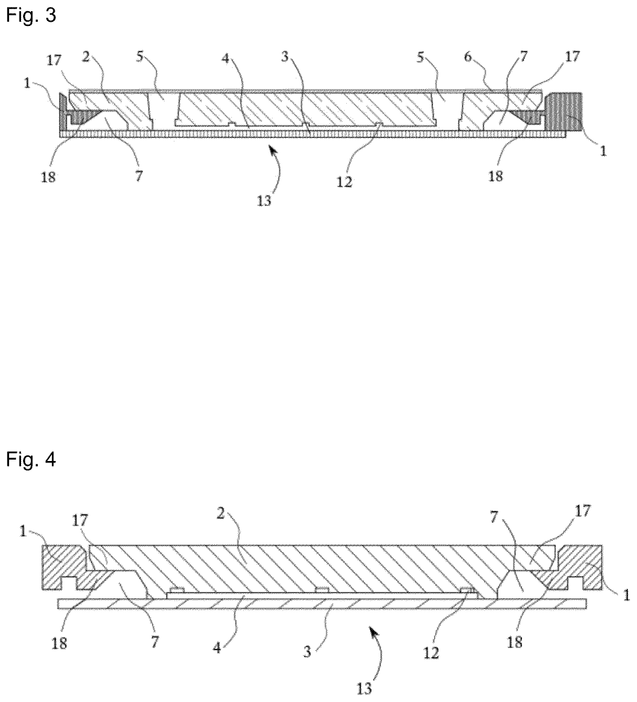

FIG. 3 is a sectional view of the active part of the chip along the axis A-A in FIG. 1,

FIG. 4 is a sectional view of the active part of the chip along the axis B-B in FIG. 1,

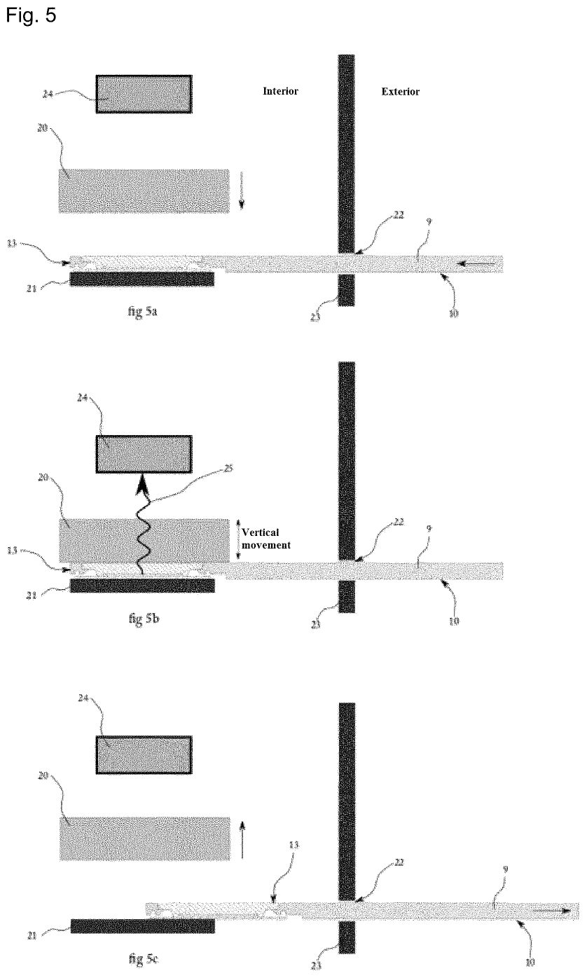

FIG. 5 are schematic views of the chip in combination with the test device,

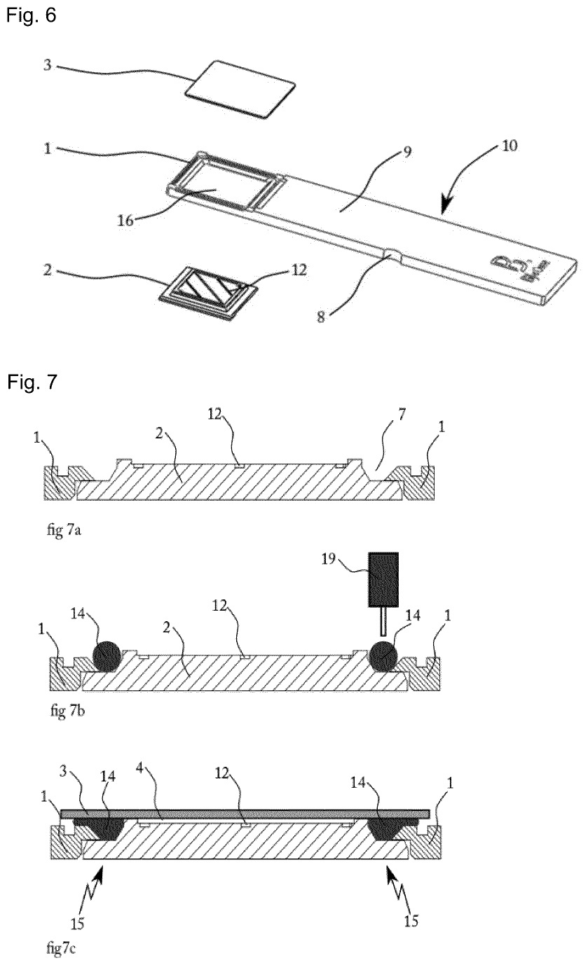

FIG. 6 is an exploded view of the chip according to the invention before bonding the elements of the active part of the chip,

FIG. 7 depict the different steps of bonding the window and the metal part to make the active part of the chip,

FIG. 8 is a schematic bottom and top view of a multi-chamber sample chip, without the metal wafer,

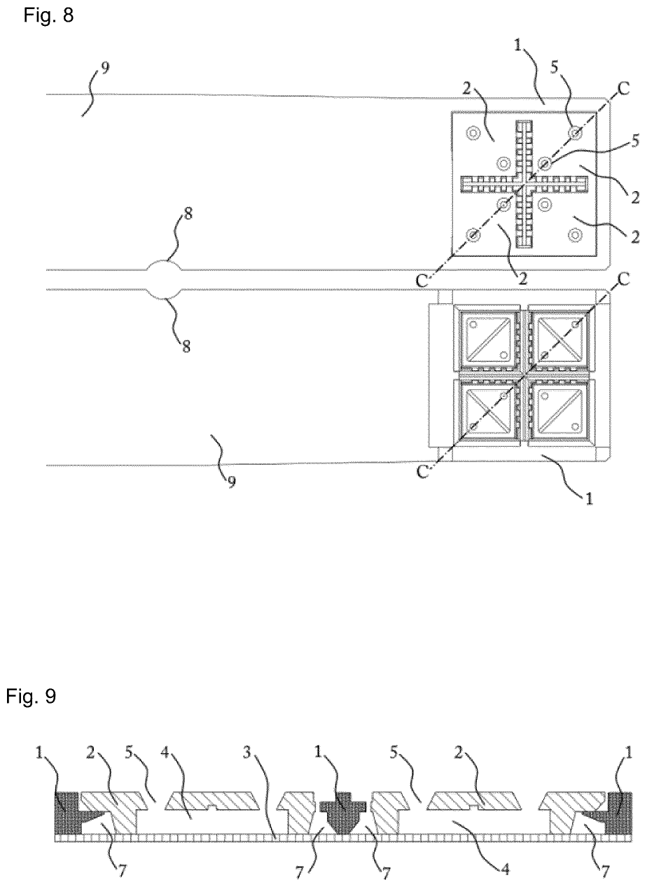

FIG. 9 is a cross-sectional view of the multi-chamber chip in FIG. 8 along the axis C-C in this figure.

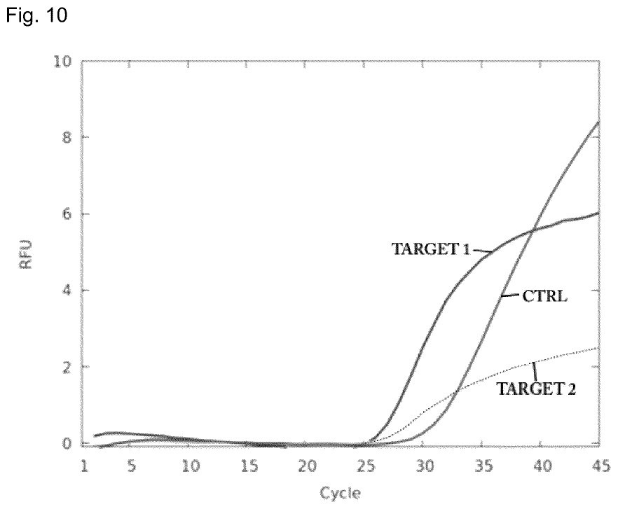

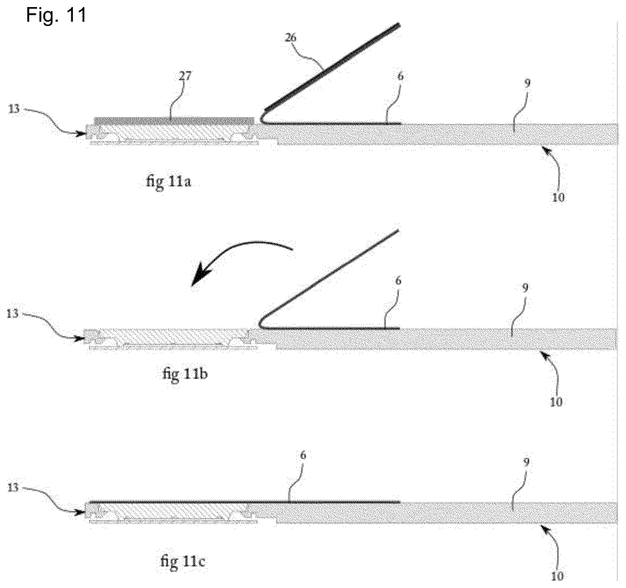

FIG. 10 depicts curves representing the fluorescence signal of different samples (RFU on the ordinate) as a function of the number of cycles (on the abscissa).

FIG. 11 depict the different stages of removing and gluing the protective and sealing films.

In these figures, the same elements have the same references.

In FIG. 1, the sample chip according to the invention is shown according to a preferred embodiment in the form of a rectangular wafer 10. Said parallelepiped-shaped wafer 10 made out of an opaque material has a length approximately five times its width in the figure (preferably between 50×10 mm (and a thickness of at least 1 mm) and 200×100 mm (and a thickness of at most 10 mm)). It is provided in its active part 13, (left part in the figure) with a substantially square opening 16 (see FIG. 6) surrounded by an opaque frame 1 in which is housed a transparent window 2. This is provided with two openings 5 located on a diagonal of the window 2 and communicating with the chamber 4 (see FIGS. 3 and 4) provided with grooves 12, said openings 5 allowing for one of them the introduction of the sample to be analyzed and for the other the evacuation of the atmosphere in the chamber 4. In the extension and in the same plane as the frame 1 is located the tab 9 provided on one of its sides with a notch 8 serving as polarizing means during the introduction of the rectangular plate 10 into the test device, not shown in the figure. In this FIG. 1, a top view of the sample chip is shown, while FIG. 2 shows a bottom view of the same sample chip. In this FIG. 2, a metal plate 3 is housed in the opening 16, thus closing the active part 13 of the sample chip. Said metal plate 3, in the extension of the tab 9, will be slightly in relief (above) with respect to the tab 9 in order to achieve good thermal and mechanical contact with the thermalization element 21 (FIG. 5).

FIG. 3 represents a sectional view along the axis A-A (diagonal of the active part 13) defined by the two openings (or injection holes). The transparent window 2 rests with the help of its peripheral end 17 on a rim 18 secured to the frame 1, leaving a groove 7 into which an adhesive (silicone or other) will be injected all around the window 2, making it possible to fix the metal plate 3 to the window 2 and to the frame 1 in a sealed manner. The metal plate 3 thus delimits the chamber 4 into which the sample is introduced through the injection holes 5. A sealing film 6 covers the openings 5 either for sealing the openings 5 in a tight manner after injection of the sample to be analyzed into the chamber 4.

FIG. 4 represents a sectional view along the axis B-B of the active part of the sample chip. In the chamber 4 are represented several grooves 12 which facilitate the circulation of the liquid sample as well as its distribution in the chamber.

FIG. 6 represents an exploded view of the sample chip in FIG. 1, before the assembly of the window 2 and the metal plate 3 inside the opening 16 in the rectangular wafer 10.

FIG. 7 illustrates the assembly of the window 2 and the metal plate 3. With the help of an injection means 19 for a semi-liquid adhesive, we just fill the groove 7 all around the window 2 with the semi-liquid adhesive 14 such as a silicone or other material compatible with the PCR (FIG. 7b) then the metal plate 3 (FIG. 7c) is applied to the window 2 so as to seal the chamber 4 thus created. The adhesive is then polymerized (cured) with the help of a suitable UV source. The sample chip being thus prepared, it is possible to introduce the sample to be analyzed into the chip, then seal the openings 5 with the help of an adhesive PCR film and analyze the sample as shown in FIG. 5.

For this purpose we use a test device, left part of FIG. 5 (inside). It comprises maintaining means for example a mobile transparent block 20 (preferably made out of glass) through which the fluorescence measurement can be made and a sample thermalization element; (for more details on a thermalization element, reference may be made to application WO2018/114625 in the name of the Applicant). On the other side of the wall 23 of the test device (on the right in FIG. 5: exterior), the rectangular plate 10 is introduced through the opening 22 in said wall thanks to the tab 9, so as to bring the active part 13 of the chip above and into contact: the adequate positioning of the chip on the thermalization element 21 is achieved thanks to the polarizing notch 8 cooperating with complementary polarizing means in the test device. This cooperation then triggers a movement (downwards in FIG. 5a) of the glass block 20 which presses the active part 13 of the sample chip (FIG. 5b) ensuring good thermal contact of the chip (whose metal part is in contact with the thermalization element), which makes it possible to start the thermal cycling of the sample. During said cycling, the optical signal 25 resulting from the fluorescence of the sample is collected by the sensor 24, allowing real-time monitoring of the fluorescence in the chip. After a predetermined period (approximately 40 cycles) the thermal cycling is stopped and the glass block 20 (FIG. 5c) is raised to its rest position, the chip being pulled outwards with the help of the tab 9.

The chip is handled from outside the device and its insertion does not require the opening of the device. No access panels, drawers or doors are required on the test device, hence its simplicity and speed of use.

The chip is inserted through a fixed slot, then removed in the same way once the detection operation is complete.

The correct positioning of the chip is determined by the notch on the edge of the chip. Once in position, it engages a contactor (not shown in FIG. 5) which allows the locking of the system.

The maintaining and thermalization means form in this variant a mobile jaw which makes it possible to maintain the chip in position, it comprises:
a glass block mounted on a motorized platform allowing its vertical movement for the upper part,
a thermalization element (metallic for example), allowing rapid change in temperature during PCR thermal cycles for the lower part.

The pressure applied to the chip is preferably between 100 g and 10 kg (ideally distributed evenly over the entire surface of the chamber).

Once the PCR is over, the jaw opens automatically (under the control of an automatic device programmed for this purpose, in a manner known per se) releasing the chip, which can be removed by the user (FIG. 5c).

The locked position under pressure (FIG. 5b) makes it possible to ensure a maximum contact between the metal plate of the chip and the thermalization element on the one hand and to prevent the sample liquid in the chip from boiling when the temperature is around 100° C. on the other hand. But it also makes it possible to avoid possible leaks of PCR products into the device, which could contaminate it.

The transparent block, preferably made out of glass, makes it possible to collect the fluorescence signal from the sample during PCR amplification.

FIG. 8 represents a variant embodiment of the invention in which the chip according to the invention comprises 4 chambers, each being provided on one side with a metal surface for the rapid transfer of heat via the thermalizing element and on the other side with a transparent window for allowing the excitation and optical detection of the fluorophores. Each chamber can receive a different sample to be analyzed.

For the one-chamber variant or the four-chamber variant, a protective film is positioned on the window, covering the injection holes, in order to avoid contamination of the chamber during transport of the chip. This film is removed and discarded just before injecting the sample into the chip.

In FIG. 11, the self-adhesive sealing film 6, cut to the correct dimensions, is prepositioned on the tab of the chip. Only part of the sealing film is stuck on the tab, the other part, covering the window, remains protected by the protective cap until the sample is injected. Thus, the user can easily remove the protective cap and stick the sealing film to obstruct the injection holes after the insertion of the sample into the chamber, without having to worry about correctly positioning or cutting the film.

More precisely, FIG. 11 describes the variant of the configuration with two films: the sealing film 6 and the protective film 27. The protective film 27, making it possible to avoid contamination of the chamber before the use thereof, during transport for example, is removed before inserting the sample into the chip, FIG. 11a. The protective cover 26 of the sealing film 6 is removed when sealing the chip, after injecting the sample and, in FIG. 11b, the sealing film 6 is folded over the upper wall of the chip in order to hermetically cover the openings used to fill the chip, FIG. 11c.

A label having a QR code, for example, makes it possible to automatically reference each of the chips, which makes it possible to have patient follow-up and a connection with the Laboratory Information Management System (LIMS) of hospitals for medical applications. The label can also have information concerning the volume and the number of chambers available on the chip.

FIG. 9 is a cross-sectional view of the chip in FIG. 8 along the (diagonal) axis C-C. As before the grooves 7 must be filled with glue so as to fix and seal the assembly.

FIG. 10 shows the RFU fluorescence signal as a function of the number of cycles to which the samples are subjected. The TARGET 1 and TARGET 2 curves correspond to two DNA targets of the SARS-COV-2 coronavirus while the CTRL curve corresponds to the internal control. The amplification is clearly detectable from the 35th cycle, which corresponds to a rapid detection in less than 20 minutes.

Such a structure of the chip with its sealing film, its tab and its polarizing system makes it possible in particular to introduce the chip into the test device through the slot 22 without having to open the device.

1-11. (canceled)

12. A system to test a microfluidic sample chip to perform a polymerase chain reaction (PCR) type testing of biological samples, the chip having a shape of a block, said chip comprising at least one hollow chamber to receive a sample, delimited by a first wall made out of a high thermal conductivity material, a material with a thermal conductivity greater than 15 Wm⁻¹K⁻¹, and a second wall made at least partially out of a transparent material, the block comprising at least two first openings to allow introduction of the sample into said at least one hollow chamber and evacuation of the atmosphere in said at least one hollow chamber during the introduction of the sample, the first wall and the second wall being parallel to each other, the chip comprising a tab arranged in an extension of the first and second walls, and a sealing device, arranged in contact with the second wall, the system comprising:
a side wall provided with a second opening to allow a passage of the chip towards a thermalization element;
a complementary polarizing element configured to cooperate with a polarizing element on the chip;
a transparent element configured to maintain the chip in contact with the thermalization element after introduction the chip through the second opening, the contact between the chip and the thermalization element being generated by a cooperation of the polarizing element on the chip and the complementary polarizing element; and
a sensor to measure fluorescence of the sample.

13. The system of claim 12, further comprising a fluorescence imager.

14. The system of claim 12, wherein the chip has the shape of a rectangular strip, comprising, near one end of the rectangular strip, a third opening surrounded by a frame, a side of the frame which is on the tab side being opaque, wherein a plate made of the high thermal conductivity material forming the first wall is housed on one side of the third opening and a transparent block forming the second wall, the plate of high thermal conductivity material, the transparent block and the frame forming an active part of the chip.

15. The system of claim 12, wherein the polarizing element comprise a notch on the chip.

16. The system of claim 15, wherein the notch is located on the tap of the chip.

17. The system of claim 12, wherein said at least one hollow chamber comprises grooves to facilitate a flow of the sample in said at least one chamber.

18. The system of claim 14, further comprising an adhesive sealing film on the side of the block secured to the tab, extending in a direction of the third opening without being secured to the block comprising said at least two first openings communicating with said at least one hollow chamber, the adhesive sealing film being configured to adhere to the transparent block to close said at least two first openings in a sealed manner after filling said at least one hollow chamber with the sample.

19. The system of claim 12, further comprising a protective film which can be removed before using the chip, the protective film being placed on said at least two first openings to avoid contamination of said at least one hollow chamber before the introduction of the sample.

20. The system of claim 12, further comprising an identification label at the tab.

21. The system of claim 12, wherein the second wall comprises a groove arranged at a periphery of the second wall on a side of said at least one chamber in which an adhesive is arranged to fasten the second wall to the first wall.

22. The system of claim 12, wherein the chip comprises at least four chambers arranged side by side and forming a square.

23. The system of claim 22, wherein an opaque wall is arranged between each of said at least four chambers to reduce a light transmission between said at least four chambers and the external environment.

24. The system of claim 12, wherein said chip has the shape of a parallelepipedic block.

25. The system of claim 12, wherein the first wall is made of metal.

26. The system of claim 12, wherein the tab is at least partially opaque.

27. The system of claim 26, wherein the tab is made of a rigid or semi-rigid material, a material whose Young's modulus is greater than 10 MPa.

28. The system of claim 12, wherein the tab is made of a rigid or semi-rigid material, a material whose Young's modulus is greater than 10 MPa.

29. The system of claim 12, wherein the tab a tab is in the same plane as the first wall and the second wall.
